(19) United States
(12) Patent Application Publication
(10) Pub. No.: US 2021/0201222 A1
(43) Pub. Date: Jul. 1, 2021

(54) METHOD AND SYSTEM FOR ESTABLISHING AND MANAGING A VIRTUAL FLEET OF CONNECTED VEHICLES

(71) Applicant: OTONOMO TECHNOLOGIES LTD., Even Yehuda (IL)

(72) Inventor: Asaf WEISBROT, Moshav Mishmeret (IL)

(73) Assignee: OTONOMO TECHNOLOGIES LTD., Even Yehuda (IL)

(21) Appl. No.: 17/136,416

(22) Filed: Dec. 29, 2020

Related U.S. Application Data
(60) Provisional application No. 62/954,496, filed on Dec. 29, 2019.

(51) Int. Cl. G06Q 10/06

(52) U.S. Cl. CPC G06Q 10/0631

(57) ABSTRACT

A method and a system for establishing and managing a virtual fleet of connected vehicles are provided herein. The system may include: a computer processor associated with an automotive data server; a data storage associated with said automotive data server, wherein the computer processor is configured to obtain a request to form a virtual fleet being an association of two or more connected vehicles, wherein each of the connected vehicles is communicating with said automotive data server that manages a plurality of connected vehicles wherein automotive data thereof is stored in an anonymized form on said data storage, and wherein the computer processor is further configured to establish a virtual fleet of said two or more connected vehicles, responsive to said request, wherein managing said virtual fleet is carried out via said automotive data server.

### CROSS-REFERENCE TO RELATED APPLICATIONS

This application claims the benefit of U.S. Provisional Patent Application No. 62/954,496, filed on Dec. 29, 2019, which is incorporated herein by reference in its entirety.

### FIELD OF THE INVENTION

The present invention relates generally to a computerized automotive marketplace and, more particularly, to establishing and managing a virtual fleet of connected vehicles on same.

### BACKGROUND OF THE INVENTION

Prior to the background of the invention being set forth, it may be helpful to provide definitions of certain terms that will be used hereinafter.

The term “connected vehicle” as used herein is defined as a car or any other motor vehicle such as a drone or an aerial vehicle that is equipped with any form of wireless network connectivity enabling it to provide and collect data from the wireless network. The data originated from and related to connected vehicles and their parts is referred herein collectively as “automotive data”.

The term “data marketplace” or “data market” as used herein is defined as an online platform preferably implemented on a cloud that enables a plurality of users (e.g. subscribers or consumers) to access and consume data originated by various data sources (e.g. data providers). Data marketplaces typically offer various types of data for different markets and from different sources. Common types of data consumers include business intelligence, financial institutions, demographics, research and market data. Data types can be mixed and structured in a variety of ways. Data providers may offer data in specific formats for individual clients.

Data consumed in these marketplaces is used by businesses of all kinds, fleets, business and safety applications and many types of analysts. Data marketplaces have proliferated with the growth of big data, as the amount of data collected by municipalities and smart cities, businesses, websites and services has increased, and all that data has become increasingly recognized as an asset.

The term “data anonymization” as used herein is defined as type of information sanitization whose intent is privacy protection. It is the process of either encrypting or removing personally identifiable information from data sets, so that the people whom the data describe remain anonymous.

Fleet Management is a function which allows companies which rely on transportation in business to remove or minimize the risks associated with vehicle investment, improving efficiency, productivity and reducing their overall transportation and staff costs, providing compliance with government legislation (e.g., duty of care) and many more.

Today, fleet management can include a range of functions, such as vehicle leasing and financing, vehicle maintenance, licensing and compliance, supply chain management, accident management and subrogation, vehicle telematics (tracking and diagnostics), driver management, speed management, fuel management, health and safety management, and vehicle remarketing.

Currently, all of the aforementioned functions are dealt with by either an in-house fleet-management department or an outsourced fleet-management provider. Computerized fleet management platforms usually require a physical device (e.g., a “dongle”) to be physically coupled to the vehicle in order to be able to include it in a within the fleet.

### SUMMARY OF THE INVENTION

In order to overcome the drawbacks of currently available computerized fleet management systems, it has been suggested by the inventor of the present invention to harness the features of a secured automotive data marketplace to enable a computerized virtual fleet management system that does not require dongles to be coupled to the fleeted vehicles and further provide flexibility and several degrees of freedom in establishing and managing a virtual fleet.

In accordance with some embodiments of the present invention, a method and a system for establishing and managing a virtual fleet of connected vehicles are provided herein. The system may include: a computer processor associated with an automotive data server; a data storage associated with said secured server, wherein the computer processor is configured to obtain a request to form a virtual fleet being an association of two or more connected vehicles, wherein each of the connected vehicles is communicating with said automotive data server that manages a plurality of connected vehicles wherein automotive data thereof is stored in an anonymized form on said data storage, and wherein the computer processor is further configured to establish a virtual fleet of said two or more connected vehicles, responsive to said request, wherein managing the virtual fleet is carried out via said automotive data server.

Advantageously, some embodiments of the present invention enable a very quick and straightforward process of “fleeting of an un-fleeted” set of cars as long as these cars are connected cars that are, or can be registered on, a electronic automotive data marketplace. The use of the electronic automotive data marketplace configured as per the present invention may support fleet management and other fleet related service providers with access to automotive data, even in cases where the backend software of the car manufacturer does not support it, and without any hardware devices (“dongle”) attached to the cars.

One further advantage following the easy virtual fleeting of “unfleeted” cars may include providing the fleet management software with unified batch Vehicle Identification Number (VIN) activation/deactivation function across brands (e.g., of different car manufacturers).

Another advantage following the easy virtual fleeting may be providing batch activation per car manufacture, even if the car manufacturer backend software only supports consent per vehicle.

Yet another advantage would be turning the Application Programming Interface (API) of the car manufacturer to a stateful API rather than stateless API thus enabling streaming automotive data via the fleet management system which is impossible when the API is stateless.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture of one system in accordance with some embodiments of the present invention; and

FIG. 2 is a high-level flowchart illustrating non-limiting exemplary method in accordance with embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

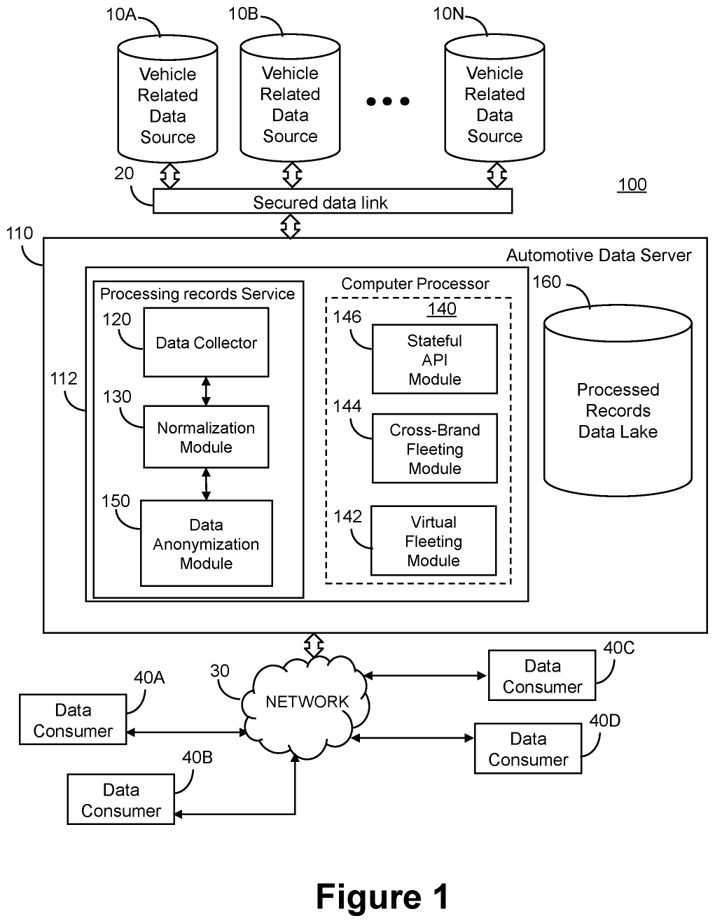

FIG. 1 is a block diagram illustrating non-limiting exemplary architecture of the system in accordance with some embodiments of the present invention. Automotive data distribution network 100 comprises at least one automotive data distribution server 110 which may, in preferable embodiments, be a secured automotive data server fully compliant with data protection and privacy regulations.

Automotive data distribution server 110 may be connected, for example via secured wireless data link 20, to a plurality of automotive data sources 10A-10N (i.e., raw data sources). As will be appreciated by those skilled in the art, each automotive data source 10A-10N may be a connected vehicle (having, for example, one or more sensing devices), road-bound infrastructure (e.g., a traffic camera, weather station, or the like) and/or a remote data repository (e.g., a third-party database, such as one comprising a list of vehicle models having certain vehicle parts). Automotive data distribution server 110 may be further connected, for example via wireless connection to network 30, with one or more clients 40A-40D. A data processing module 130 implemented by a computer processor 120 may also be included within automotive data distribution server 110. Data processing module 130 may be configured, when operated by computer processor 120, to anonymize, and preferably also normalize, automotive data obtained from automotive data sources 10A-10N and, optionally, store said anonymized automotive data within a processed automotive data store 160 (e.g., a computer disk drive, or the like).

In accordance with some embodiments of the present invention, a plurality of virtual fleeting services 140 may be implemented as software modules executed on computer processor 112 thereby enabling an effective fleeting and un-fleeting process applied to the connected cars associated with automotive data server 110.

Specifically, virtual fleeting services 140 may include a virtual fleet establishing process. In accordance with this process, computer processor 112 may be configured to obtain a request to form a virtual fleet, being an association of two or more connected vehicles, wherein each of the connected vehicle is communicating with automotive data server 110 that manages a plurality of connected vehicles, wherein automotive data thereof is stored in an anonymized form on processed records data lake 160.

In accordance with some embodiments of the present invention, computer processor 112 may be further configured to establish a virtual fleet of said two or more connected vehicles, responsive to said request, wherein managing said virtual fleet is carried out via said automotive data server.

In accordance with some embodiments of the present invention, the communicating between the connected vehicles associated with the virtual fleet and the automotive data server is carried out via a same communication means used for communicating between the automotive data server and connected vehicles which are unrelated to the virtual fleet.

In accordance with some embodiments of the present invention, the managing of the virtual fleet comprises at least one of: adding connected vehicles, removing connected vehicle, and making changes to connected vehicles that are associated with the virtual fleet.

In accordance with some embodiments of the present invention, the establishing of the virtual fleet is carried out on an on-demand basis.

In accordance with some embodiments of the present invention, the establishing of the virtual fleet may be carried out on connected vehicles that logged as an identified user at an automotive data marketplace implemented on said automotive data server.

In accordance with some embodiments of the present invention, computer processor 112 may be further configured to provide to an authorized user, automotive data relating to the connected vehicles associated with said virtual fleet.

In accordance with some embodiments of the present invention, the automotive data is obtained from said data storage.

In accordance with some embodiments of the present invention, virtual fleeting services 140 may include a virtual fleeting module 142 enabling, due to being implemented over electronic automotive data marketplace 110, an easy virtual fleeting by providing batch activation per car manufacture, even if the car manufacturer backend software only support consent per vehicle.

In accordance with some embodiments of the present invention, virtual fleeting services 140 may include a cross-brands fleeting module 144 enabling, since they are implemented over an electronic automotive data marketplace 110, an easy virtual fleeting of “unfleeted” cars and may include providing the fleet management software with unified batch Vehicle Identification Number (VIN) activation/deactivation function across brands so that cars of different manufactures can be fleeted easily.

In accordance with some embodiments of the present invention, virtual fleeting services 140 may include a stateful Application Programming Interface (API) module 146 transforming, since it is implemented over an electronic automotive data marketplace 110, the (API) of the car manufacturer to a stateful API rather than stateless API thus enabling streaming automotive data via the fleet management system.

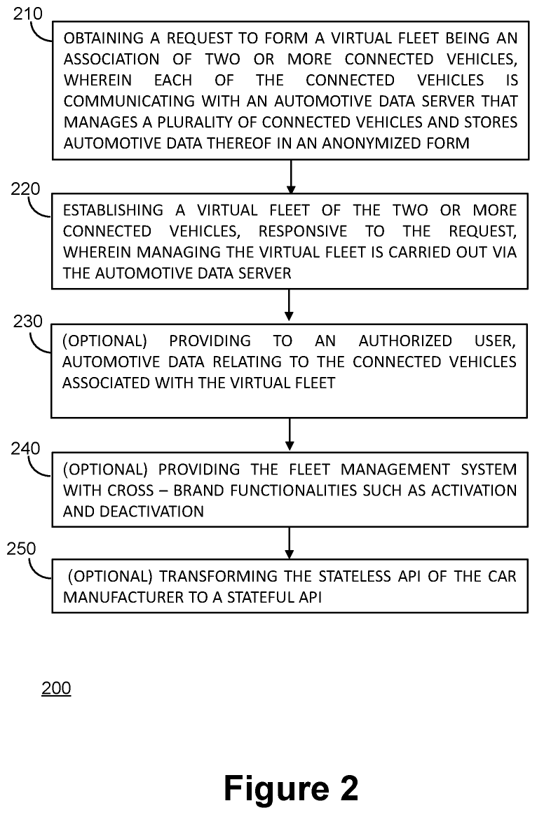

FIG. 2 is a high-level flowchart illustrating non-limiting exemplary method in accordance with some embodiments of the present invention. A method 200 of establishing and managing a virtual fleet of connected vehicles is illustrated herein. Method 200 may include the following steps: obtaining a request to form a virtual fleet being an association of two or more connected vehicles, wherein each of the connected vehicle is communicating with an automotive data server that manages a plurality of connected vehicles and stores automotive data thereof in an anonymized form 210; establishing a virtual fleet of said two or more connected vehicles, responsive to said request, wherein managing said virtual fleet is carried out via said automotive data server 220; and optionally, providing to an authorized user, automotive data relating to the connected vehicles associated with said virtual fleet 230; optionally providing the fleet management system cross-brand functionalities (e.g., activation/deactivation) 240; and optionally, transforming the stateless API of the car manufacturer to a stateful API 250.

Advantageously, some embodiments of the present invention enable fleet management functionalities for un-fleeted cars by adding capabilities to manage single cars as a fleet. For example, If a CAR MANUFACTURER does not support fleet capabilities, some embodiments of the present invention enable add them on top of single car access. These functionalities may include “add vehicle” “change vehicle”, “remove vehicle” and “get report for the fleet”.

In a case that the car manufacturer does not support fleet management or cannot support it for a set of specific vehicles, the virtual fleeting in accordance with some embodiments of the present invention may be provided as a paid service by the automotive marketplace in accordance with some embodiments of the present invention.

Further advantageously, some embodiments of the present invention enable fleet management for multi brand through a single interface. Currently, fleet management is limited to managing a fleet of cars of the same car manufacturer. By some embodiments of the present invention fleet management companies may be provided with a single interface to manage multiple car manufacturer brands, thereby addressing a major problem. This way, it may be possible to manage any car manufacturer through one interface, even if the car manufacturer does not support fleet management at all.

Further advantageously, some embodiments of the present invention provide stateful capabilities for a stateless API. Either the automotive marketplace in accordance with some embodiments of the present invention or a car manufacturer or data consumer are required to obtain the driver's consent to collect all information which collected through the API and kept stateless. Currently, all APIs that are being used on personal data are stateless. However, in accordance with some embodiments of the present invention, once consent has been granted, the automotive data server starts collecting the data and offer reports that users can use with insurance, leasing, loans.

Currently, in a case of an API of a car manufacturer which is stateless, and configured to retrieve the last read of the odometer of the car, every time a request of the type “GetOdometer” is made, only the latest odometer read may be received, without being able to ask about history or previous odometer reads. While every API may store the data history, doing so takes the control from the driver and forces him or her to track the “data trail” of all APIs involved in providing automotive data services.

Advantageously, it would be possible to offer the data history upon consent with the virtual fleeting service in accordance with some embodiments of the present invention, and make the API developer work easier. The driver would also be more pleased when a proper framework can provide him or her with the ability to directly request data history and/or a continued steam of data from all APIs.

In order to implement the method according to some embodiments of the present invention, a computer processor may receive instructions and data from a read-only memory or a random-access memory or both. At least one of aforementioned steps may be performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++, Python or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional elements.

It is to be understood that where the claims or specification refer to “a” or “an” element, such reference is not be construed that there is only one of that elements.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of establishing and managing a virtual fleet of connected vehicles, the method comprising:
obtaining a request to form a virtual fleet, being an association of two or more connected vehicles, wherein each of the connected vehicles communicates with an automotive data server that is configured to manage a plurality of connected vehicles and to store automotive data thereof in an anonymized form; and
establishing a virtual fleet of said two or more connected vehicles, responsive to said request, wherein managing said virtual fleet is carried out via said automotive data server.

2. The method according to claim 1, wherein the communicating between the connected vehicles associated with the virtual fleet and the automotive data server is carried out via a same communication means used for communicating between the automotive data server and connected vehicles which are unrelated to the virtual fleet.

3. The method according to claim 1, further comprising providing the fleet management system with cross-brand activation/deactivation

4. The method according to claim 1, further comprising transforming the stateless API of the data provider to a stateful API.

5. The method according to claim 1, wherein the managing of the virtual fleet comprises at least one of: adding connected vehicles, removing connected vehicle, and making changes to connected vehicles that are associated with the virtual fleet.

6. The method according to claim 1, wherein the establishing of the virtual fleet is carried out on an on-demand basis.

7. The method according to claim 1, wherein the establishing of the virtual fleet is carried out on connected vehicles that logged as an identified user at an automotive data marketplace implemented on said automotive data server.

8. The method according to claim 1, further comprising providing to an authorized user, automotive data relating to the connected vehicles associated with said virtual fleet.

9. The method according to claim 1, wherein the automotive data is obtained from the automotive data server.

10. A system for establishing and managing a virtual fleet of connected vehicles, the system comprising:
a computer processor associated with an automotive data server; and
a data storage associated with said automotive data server,
wherein the computer processor is configured to obtain a request to form a virtual fleet, being an association of two or more connected vehicles, wherein each of the connected vehicles communicates with said automotive data server that is configured to manage a plurality of connected vehicles, wherein automotive data thereof is stored in an anonymized form on said data storage, and
wherein the computer processor is further configured to establish a virtual fleet of said two or more connected vehicles, responsive to said request, wherein managing said virtual fleet is carried out via said automotive data server.

11. The system according to claim 10, wherein the communicating between the connected vehicles associated with the virtual fleet and the automotive data server is carried out via a same communication means used for communicating between the automotive data server and connected vehicles which are unrelated to the virtual fleet.

12. The system according to claim 10, wherein the managing of the virtual fleet comprises at least one of: adding connected vehicles, removing connected vehicle, and making changes to connected vehicles that are associated with the virtual fleet.

13. The system according to claim 10, wherein the establishing of the virtual fleet is carried out on an on-demand basis.

14. The system according to claim 10, wherein the establishing of the virtual fleet is carried out on connected vehicles that logged in as an identified user at an automotive data marketplace implemented on said automotive data server.

15. The system according to claim 10, wherein said computer processor is further configured to provide to an authorized user, automotive data relating to the connected vehicles associated with said virtual fleet.

16. The system according to claim 15, wherein the automotive data is obtained from said data storage.

17. A non-transitory computer readable medium comprising a set of instructions that, when executed, cause at least one computer processor to:
obtain a request to form a virtual fleet being an association of two or more connected vehicles, wherein each of the connected vehicle communicates with a automotive data server that manages a plurality of connected vehicles, wherein automotive data thereof is stored in an anonymized form on a data storage associate with said automotive data server, and
establish a virtual fleet of said two or more connected vehicles, responsive to said request, wherein managing said virtual fleet is carried out via said automotive data server.

18. The non-transitory computer readable medium according to claim 17, wherein the communicating between the connected vehicles associated with the virtual fleet and the automotive data server is carried out via a same communication means used for communicating between the automotive data server and connected vehicles which are unrelated to the virtual fleet.

19. The non-transitory computer readable medium according to claim 17, wherein the managing of the virtual fleet comprises at least one of: adding connected vehicles, removing connected vehicle, and making changes to connected vehicles that are associated with the virtual fleet.

20. The non-transitory computer readable medium according to claim 17, wherein said computer processor is further configured to provide to an authorized user, automotive data relating to the connected vehicles associated with said virtual fleet.
